(19) United States
(12) Patent Application Publication
(10) Pub. No.: US 2011/0276506 A1
(43) Pub. Date: Nov. 10, 2011

(54) SYSTEMS AND METHODS FOR ANALYZING CANDIDATES AND POSITIONS UTILIZING A RECOMMENDATION ENGINE

(76) Inventor: Steven J. Schmitt, Pittsburgh, PA (US)

(21) Appl. No.: 13/100,793

(22) Filed: May 4, 2011

Related U.S. Application Data
(60) Provisional application No. 61/331,371, filed on May 4, 2010.

(51) Int. Cl. G06Q 10/00

(52) U.S. Cl. 705/321

(57) ABSTRACT

Methods and systems for assigning generating referrals within a talent management platform are described herein. Embodiments provide for registering platform members, obtaining profile information from the members and from member external networks, analyzing the profile information to obtain subjective information about the members and potential referrals, generating referrals for open positions by applying the subjective information to requirements of the open positions.

### CROSS REFERENCE TO RELATED APPLICATION

This application claims the benefit of U.S. Provisional Patent Application Ser. No. 61/331,371, entitled “Systems and Methods for Multi-Level Professional Referral Social Networking,” filed on May 4, 2010, the contents of which are incorporated by reference as if fully set forth herein.

### FIELD OF THE INVENTION

The subject matter presented herein generally relates to Internet-based talent management in relation to professional recruitment and candidate referrals, including automated processes for providing candidate recommendations, and systems and methods therefor.

### BACKGROUND

Employers currently have a limited number of resources for locating candidates for open positions. Typical methods include print advertising and partnering with staffing and recruitment agencies. More recently, a first wave of web sites established the feasibility of utilizing the Internet to post employment positions and search for potential candidates, for example, through online job boards. Among these web sites are resume posting and job search sites, such as MONSTER.COM®. MONSTER.COM is a registered trademark of TMP Worldwide Inc. in the United States and other countries. Although the Internet is now considered a vital job placement resource, online job boards and recruitment sites have long been losing their effectiveness, especially in high demand industries such as information technology and healthcare, and have not adapted to fully realize the potential of recent technological advances.

### BRIEF DESCRIPTION OF THE SEVERAL VIEWS OF THE DRAWINGS

FIG. 1 provides example talent management platform interface according to an embodiment.

FIG. 2 provides an example member network according to an embodiment.

FIG. 3 provides an example multi-level member network according to an embodiment.

FIG. 4 provides an example member network according to one embodiment.

FIG. 5 provides an example of information available to the talent management platform according to an embodiment.

FIG. 6 provides an example recommendation engine accessing a member network according to an embodiment.

FIG. 7 provides an example of a recommendation engine searching for candidates for a job listing according to an embodiment.

FIG. 8 illustrates example staffing agencies' sales and recruiting functions.

FIG. 9 provides an example job referral exchange according to an embodiment.

FIG. 10 provides an example computer system.

### DETAILED DESCRIPTION

It will be readily understood that components of the embodiments, as generally described and illustrated in the figures herein, may be arranged and designed in a wide variety of different configurations in addition to the described example embodiments. Thus, the following more detailed description of embodiments, as represented in the figures, is not intended to limit the scope of the invention, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that various embodiments can be practiced without one or more of the specific details, or with other methods, components, materials, et cetera. In other instances, well-known structures, materials, or operations are not shown or described in detail to avoid obfuscation. Throughout this description, example embodiments are described in connection with a computer, such as a desktop, laptop, or notebook computer; however, those skilled in the art will recognize that certain embodiments are equally applicable to other types of electronic devices.

A successful organization today must recruit and retain the best talent to remain competitive. However, there is little alternative but to rely on inefficient conventional methods, such as print advertising and online job boards, or to partner with firms in the professional staffing industry that depend on inefficient tools, technologies, and processes. These firms include staffing, recruiting, headhunting, and consulting firms. Although these professional staffing firms are able to provide some assistance to employers, research suggests they have ultimately created an environment that lacks certain necessary characteristics, such as efficiency, trust, reliability, and accountability.

While endeavoring to recruit and retain talent, human resource (HR) departments are also being faced with several other critical issues, including a massive shortage of skilled professionals, a hyper-competitive business climate, a complicated global workforce, and the increased specialization of labor. These issues are exacerbated in industries where for qualified professionals significantly exceeds supply, such as information technology, healthcare, and energy. Accordingly, employers and HR managers, who are often under enormous pressure to attract talent, are seeking innovative, trustworthy, and effective ways to connect with qualified candidates and to maintain current operations in line with their organization's efforts to fuel new growth.

Personal referrals have long been an effective source for obtaining potential candidates for job openings. Referrals are important because they create a connection between the employer and the candidate that an application from an unknown or non-recommended individual simply cannot provide. However, most employers cannot rely on referrals alone because of their personal and incidental nature.

Certain organizations have attempted to create platforms that allow individuals to refer candidates for open positions. For example, an organization may have an internal referral program wherein an employee receives some form of compensation for referring a qualified candidate for an open position or, more commonly, if the referred candidate is hired for the open position. Similarly, certain professional staffing firms may have referral systems wherein individuals outside an organization are compensated for recommending a qualified candidate who ultimately is hired for an open position.

Although such methods potentially provide employers with candidate referrals for open positions, the platforms do not provide processes for effectively recommending candidates beyond basic, conventional matching methods. A common example involves an individual locating a candidate based on an ordinary keyword search that merely matches keywords from a person's profile or resume with a description of an open position. Keyword search and related methods may be able to locate persons with some employment or academic characteristics in common with the position requirements. However, such search results produce a large percentage of false matches, wherein a candidate is actually not a good fit for the position. For example, a candidate may have the required industry experience, but is not interested in leaving his current position, or a candidate may have the appropriate academic background but lacks the necessary employment experience. As such, referral systems according to current methods often overwhelm employers with candidates that are actually not a good fit for the position

A highly sought after source of talent is passive job seekers—potential candidates not actively pursuing job opportunities, but who may consider a new position if presented with the right situation. These individuals are in demand because they are considered to represent the most talented and productive segment of the workforce. However, these individuals are difficult to locate and present with new opportunities because they are not actively looking for a job. Current job referral methods are not adequately configured to locate passive candidates because these methods do not have the ability to locate such candidates and communicate with them.

Embodiments provide an Internet-based professional talent management platform. More specifically, embodiments provide systems for providing access to professional talent, including, but not limited to, through recruitment and referral systems. For example, embodiments provide systems and methods for the consistent generation of quality referrals to employers. Embodiments described herein are configured to assist individuals, such as hiring managers, in finding the most qualified employee and/or contractor as quickly as possible.

Embodiments are configured to implement an Internet-approach that transforms the traditional, hierarchical staffing model into a model based on an online long-term incentive referral network. Certain embodiments are configured to use a unique business model and software to match demand for qualified employees with a supply of job seekers via the Internet. For example, certain embodiments assist in identifying increased numbers of qualified talent in a more efficient way, transforming conventional talent management approaches.

As such, embodiments provide for a recommendation engine configured to recommend candidates for positions based on certain candidate factors. Illustrative and non-restrictive examples of candidate factors according to embodiments include whether the candidate's background matches the job requirements, how long the candidate has stayed at his current position, and whether the candidate has moved to a higher position each time that he has changed jobs. Accordingly, embodiments are able to recognize the distinctive characteristics of high value candidates for a particular position based on a dynamic set of factors.

In addition, embodiments provide incentives for members and associates of the professional talent management platform to actively participate in the recruitment and referral systems. As a non-limiting example, one embodiment provides that the incentives may consist of certain rewards allocated to platform members for directly or indirectly referring a candidate to an open position posted on the platform. Furthermore, embodiments are configured to generate a system of metrics for referrals made within the talent management platform. According to embodiments, each platform member has a credibility score that represents a measure of the quality of his referrals made within the platform. As a non-limiting example, the quality of the referrals made may be measured according to certain referral characteristics, including, but not limited to, how the referred candidate fits the job requirements, whether the referred candidate actually is interested in the position, and feedback from the referral target.

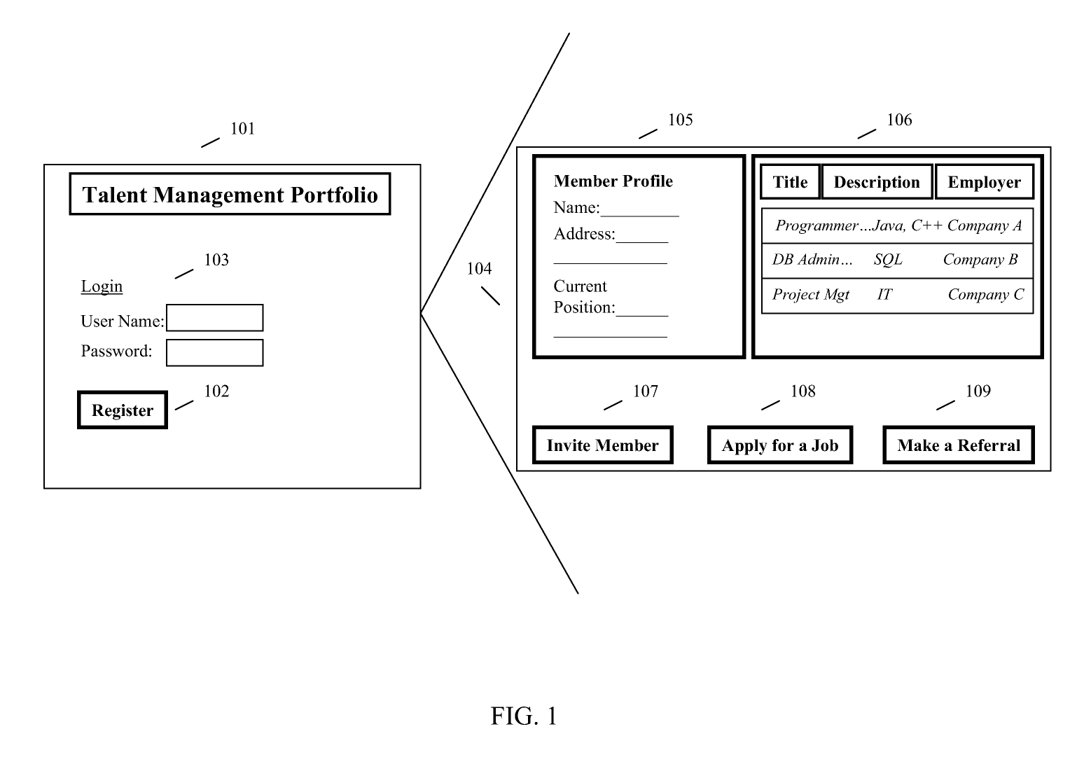

Referring to FIG. 1, therein is depicted an example talent management platform interface according to an embodiment. In the embodiment depicted in FIG. 1, the talent management platform is implemented as an Internet-based service with an interface 101 accessible through a web browser. According to embodiments, individuals may register 102 as a new member at the platform web site. As an example member, consider an information technology professional, such as a software engineer, a network engineer, a project manager, a help desk professional, a database analyst, an ERP specialist, a web developer, a graphics designer, or a technical writer. In addition, embodiments provide that the member may take on different roles as part of his or her membership. Illustrative and non-restrictive examples of member roles include seeking full time employment, referring colleagues for open positions (jobs), and acting as a hiring manager or a consultant for one or more companies.

Registration may include choosing a member name and password, filling out a member profile (which may include, for example, both professional and personal information fields) and saving the membership information. In at least one embodiment, becoming a member and maintaining a membership will not require a fee. In another embodiment, a member may register using credentials from a social networking service, including, but not limited to, LinkedIn® or Facebook®. Facebook is a registered trademark of Facebook, Inc. LinkedIn is a registered trademark of LinkedIn Ltd.

After registering as a platform member, embodiments provide that a user may login 103 to the platform and access certain functions and services 104. For example, the functions and services may be available through a member profile or dashboard interface. As non-limiting examples, functions and services 104 may include creating and editing a member profile 105, viewing posted jobs 106, inviting members to join the platform 107, applying for a job 108, and referring a candidate for a job 109.

After a member has registered, certain embodiments provide that the talent management platform may utilize various methods to verify the member. According to embodiments, verification may be rigorous and may include one or more of the following: credit check(s), drug screening(s), verification of resume information (for example, education and employment information), and requiring direct invitation from an existing member.

Certain embodiments are configured to track a large amount of information regarding members. Such information may include, but is not limited to, social networking site information, including profile and connection information; information resulting from background checks, credit checks, and/or drug screenings; customer ratings; basic demographics; resume information; and member invitation, platform promotional, and job listing procurement information. Such information may be gathered and organized by certain embodiments to form a repository of information regarding a particular member or members. In addition, embodiments may be configured to require such information of the members and that some or all of the information be made accessible, for example, in an effort to create an exclusive set of members, as reflected by the information gathered and made available regarding the members.

Embodiments provide for talent management platform function interfaces that may be accessed from within the talent management platform interface. For example, a community-based user interface modality may be available according to embodiments, which integrates social networking sites, communications modalities (e.g., email and instant messaging), a jobs posting service, as well as various other Web 2.0 capabilities. A credibility score interface may include, but is not limited to, a member rating system, a system providing periodic to continuous feedback for members, and a validity checking system that may conduct and display results relating to various checks, such as credit and criminal background checks and the like. In addition, embodiments provide for one or more interfaces that may include a reserving capability, a recruiting capability, or a retaining capability for members conducting recruiting services. Certain embodiments may further provide a growth interface according to an embodiment that includes, for example, an incentive plan and tracking thereof, a dashboard for hosting widgets, and accounting capabilities.

Embodiments provide for a talent management platform user interface wherein a member may access multiple aspects of the platform from a unified interface. As a non-limiting example, the member may access the interface and view a list of connections, which may comprise platform network connections or external network connections (e.g., social network connections), and associated information. For each connection, a list of jobs wherein the connection may be a quality referral may be listed along with information related to each listed job. As such, a user may view all of his connections and all available jobs where the connection may be a quality referral from a common interface. According to embodiments, the member may select to view all of the available jobs and the interface would display potential referrals derived from the member's connections. In addition, embodiments provide that the member may be able to use the interface to view all available jobs, for example, ranked by how well they fit the member's profile and qualifications.

Embodiments are configured to provide members with opportunities including but not limited to contract assignments, full time jobs, projects, and freelance opportunities. Certain embodiments are configured to reward members for certain services, such as referring another member successfully or building a network from which a qualifying referral is received. According to embodiments, rewards may take various forms, including, but not limited to, increased member ranking, financial or other forms of remuneration, charitable donations, advanced access to job postings, enhanced referral abilities, or some combination thereof. In addition, embodiments are configured to make automated attribution of rewards to members. For example, a member may link a payment account to, or establish an in-house account with, the platform system and receive regular (for example, monthly) distributions of rewards (for example, payments/account deposits) for his or her qualifying events. Furthermore, certain other embodiments provide that members may designate one or more charitable endeavors to receive earned rewards.

Each member may be associated with a network according to embodiments. For example, embodiments provide that a user may invite members to join his network, while other embodiments may leverage social networking web sites to assist members in building a network, as by leveraging a member's existing contacts from other social networking sites as a starting point for identifying candidates for referral.

According to embodiments, if a user registers using social networking credentials, the talent management platform may obtain available social network information, including the profile information of the user's social network contacts. As such, certain embodiments are configured to interface the talent management platform with various other social networking web sites and other web sites to facilitate information retrieval and importation from these other web sites, such as contacts lists, member characteristics, and organization characteristics. The member's network may, for example, comprise a referral network, such that a member may receive a reward when any one in his or her network receives a reward.

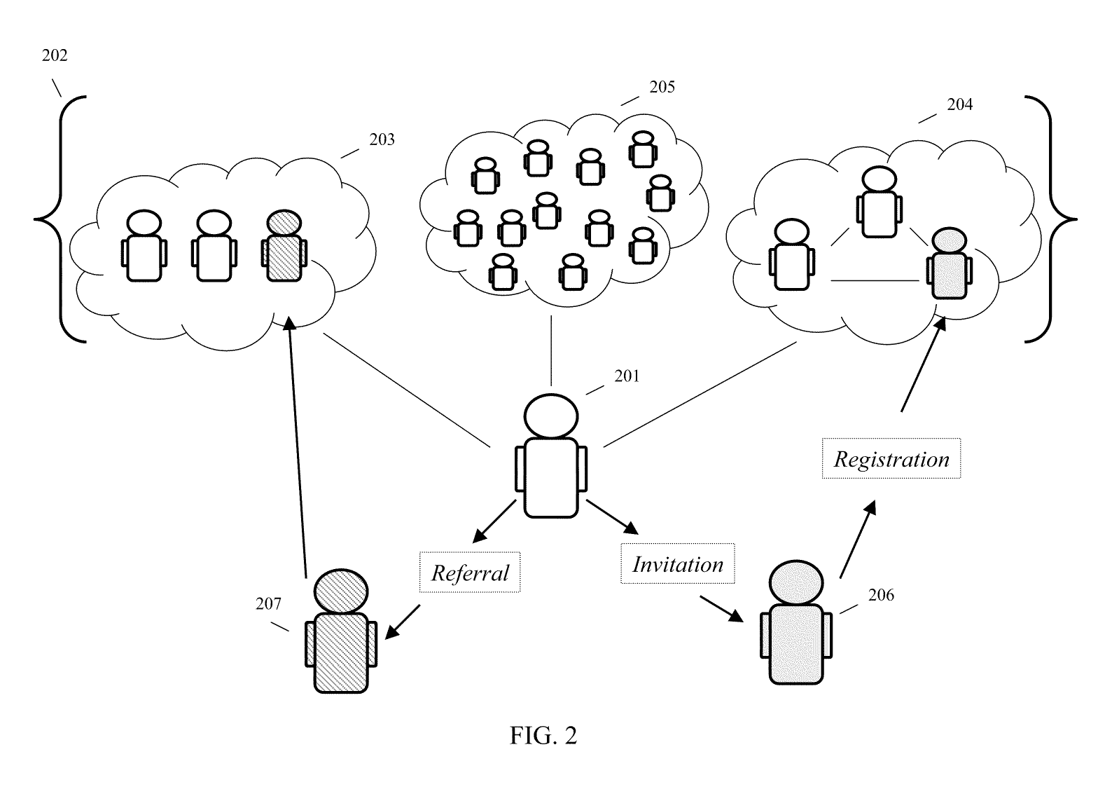

Referring to FIG. 2, therein is depicted an example member network for according to an embodiment. A talent management platform member, Member 1, 201 may have a network 202 consisting of connections, including, but not limited to, referral connections 203, member connections 204, and outside network connections 205.

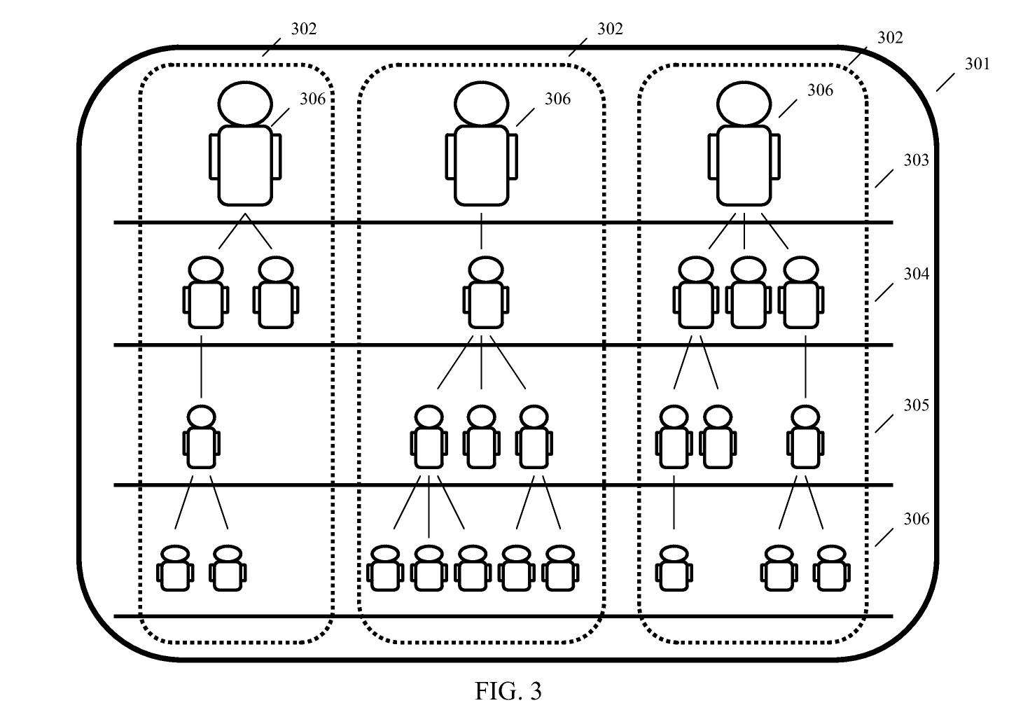

According to embodiments, member connections 204 may consist of platform members in Member 1's 201 network 202. For example, if Member 1 201 invites Member 2 206 to join the talent management platform and Member 2 206 registers with the platform, Member 2 206 is in Member 1's 201 network 202, more specifically, as a member connection 204. In addition, platform members who register responsive to invitations from members in Member 1's 201 network 202 become a part of Member 1's 201 network 202, for a certain number of levels. FIG. 3, discussed below, provides more detail regarding different member connection levels. Embodiments provide for the automated handling of invitations, for example, by a member executing an invitation function from the talent management platform interface and providing certain information regarding the invited individual, such as the individual's email address. The invitee subsequently may respond to the request and register as a member of the platform.

Embodiments provide that referral connections 203 may be comprised of platform referrals related to Member 1 201, such as referrals made directly by Member 1 or referrals made by members of Member 1's 201 network 202 (i.e., member connections 204) for a certain number of levels. In a non-limiting example provided in FIG. 2, Member 1 201 refers Candidate 1 207 for a position and, in response, Candidate 1 207 becomes linked to Member 1 201 as a referral made by Member 1 201 within the platform. Furthermore, embodiments provide that a member's network may consist of outside network connections 205, such as social networks the member has joined. For example, if Member 1 201 is a member of LinkedIn®, Member 1's 201 LinkedIn® accessible network of connections may be accessed as outside network connections 205 in Member 1's 201 network 202.

Embodiments are not limited to the types, number, and form of the networks 202-205 described in FIG. 2, as this figure depicts one non-restrictive embodiment and the networks provided therein are for illustrative purposes. According to embodiments, many different networks and sub-networks may be provided in multiple potential configurations. In addition, embodiments provide that there may be overlap between the different networks. As an illustrative and non-restrictive example, Member 1 201 may invite a member from his outside network connections 205, if the invitee accepts the invitation, then the invitee will become a member connection 204 of Member 1 201. Thus, the invitee will belong to Member 1's 201 outside network connections 205 and his member connections 204. Furthermore, if Member 1 201, then refers the invitee to a position within the platform, the invitee will additionally belong to Member 1's referral network 203.

Embodiments provide for a multi-level or tiered network. In a non-limiting example, a member network may be comprised of four levels, with the member himself occupying the first level. According to embodiments, if a first member directly interacts with a second member, the second member may become a member of the first member's network at the second level (the first level below the member himself). Non-limiting examples of interaction include inviting a member to join the network or referring an individual for a position. In addition, when a member in the first member's second level directly interacts with a third member, the third member may become a member of the first member's third level (and a member of the second member's second level). Embodiments provide that the addition of connections within a member network may be added accordingly, including to more remote levels.

Referring to FIG. 3, therein is depicted an example multi-level member network according to an embodiment. The talent management platform network 301 consists of platform members each associated with a member network 302, wherein each member network may be comprised of multiple levels. In the illustrative and non-restrictive example shown in FIG. 3, the member network has four levels 303-306, although more or less levels are possible. According to embodiments, the first level 303 consists of platform members 307. The remaining levels 303-306 consist of the network connections of the members 307 and indicate the relatedness between platform members. For example, if a first member invites an invitee to join the network and the invitee registers with the network, the invitee becomes a member of the first member's network at the second level 303 (the first level below the actual member). In addition, embodiments provide for multiple types of networks (not shown), such as a public platform network and one or more private networks each associated with a private entity.

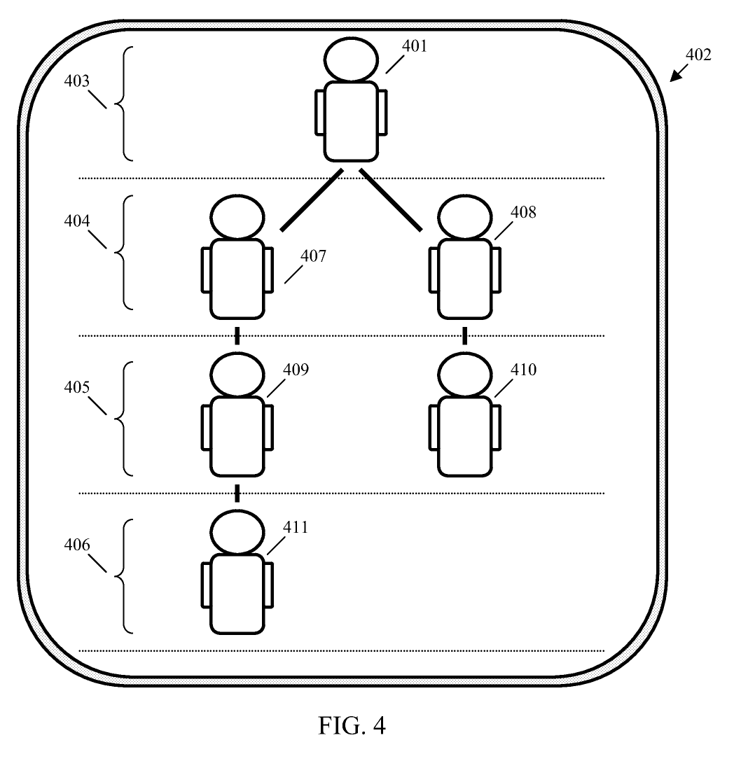

In FIG. 4, therein is provided an example member network according to one embodiment. Member 1 401 is associated with a network 402 comprised of four levels 403-406. The first level 403 consists only of Member 1 401, who may be considered the “parent” node of the network 402. The second level 404 consists of network members directly related to Member 1, such as through invitation or referral, and may be considered the “child” nodes of the network 402. A non-limiting example provides that if Member 1 401 invites Member 2 407 to join the talent management platform and Member 2 407 subsequently registers, then Member 2 407 becomes a member of Member 1's 401 network 402. Member 2 407 is in the second level 403 because Member 2 407 is directly related to Member 1 401 because Member 2 407 joined the platform responsive to an invitation from Member 1 401. In another non-limiting example, if Member 1 401 referred Member 3 408 to a position, Member 3 408 becomes connected within Member 1's 401 network 402 at the second level 403 because Member 3 408 is directly related to Member 1 401 through the referral.

The third 405 and fourth 406 levels are indirectly related to Member 1 401 through activity by members related to Member 1 401 at a higher level. A non-restrictive illustration provides that if Member 2 407 invites Member 4 409 to join the platform, when Member 4 409 registers, Member 4 409 becomes a connection in Member 1's 401 network 402 at the third level 405. Member 4 409 is indirectly related to Member 1 401 because Member 4 409 joined the network responsive to an invitation from a member related to Member 1 401 (i.e., Member 2 407). Another example provides that if Member 3 408 refers Member 5 410 for a position, Member 5 410 subsequently joins Member 1's 401 network 402 as a third level 405 member. Embodiments provide that the non-limiting example of network relationships may continue for one or more levels, such as level four 406 depicted in FIG. 3. For example, if Member 4 409 subsequently refers Member 6 411 for a position, Member 6 411 may be connected to Member 1 401 in level four 406 of the network 402.

In addition, embodiments provide that there may be overlap and/or shared connections between member networks. As a non-limiting example, Member 4 409 is a second level member of Member 2's 407 network (not shown) because Member 4 409 is directly related to Member 2 407 through Member 2's 407 invitation. In addition, Member 4 409 is also a member of Member 1's 401 network 402 at the third level 405. In addition, Member 5 410 is a second level connection in the network of Member 3 408 (not shown) and a third level 405 connection in the network 402 of Member 1 401.

Following registration and verification, embodiments provide that members may have access to job postings, which may include a frequently updated listing of job postings, such as daily updated job postings. A member, in response to reviewing the job postings, may search his or her personal network for individuals that may match the job postings. Embodiments may automate this search by automatically suggesting certain “friends” or other such individuals connected to the member that may qualify. Such automated suggesting may include, for example, comparing one or more metrics associated with the job posting to one or more metrics associated with the “friends” profiles in the member's personal network on the system (which again may be imported from other web sites). Thereafter, the member may make a referral.

Certain embodiments allow for better, faster and cheaper location of talent compared to prior talent management approaches, for example by leveraging member's use of social networking web sites. This is in part because according to certain embodiments, more people will be looking for the desired talent, for example, by employing contacts from other networks, including social networking sites. Members trying to identify qualified talent will be highly motivated to do so, because of both positive incentives (for example, remuneration) and negative incentives (decreased member ranking or credibility score), which may be accrued over time. Moreover, certain embodiments provide for more passive candidates to be identified, for example by leveraging interaction with other social networking web sites, with enforced credibility for members recommending these passive candidates. Certain embodiments will reduce costs associated with talent management by virtue of having less turnover. For example, as a result of more qualified candidates being identified and recommended in the first place due to a long term incentive approach according to embodiments.

A system according to embodiments may include one or more modules such as a candidate module, a jobs module, a credibility score module, a reference/referral module, a rewards module and a communications module. The system may communicate via the communications module with one or more remote devices such as a member's client device (for example, a personal computer or cell phone), one or more other web sites hosted by remote devices (for example, servers), such as social networking sites or other web sites (for example, customer sites or industry web sites).

According to embodiments, the candidate module may be configured to store one or more lists of potential candidates, for example, members within a particular member's network of contacts or other contacts as identified from other web sites. Embodiments provide that the jobs module may be configured to store one or more jobs listings, such as listings submitted by potential employers looking for qualified professional talent. Embodiments provide that the referral/reference module may be configured to store one or more lists of contacts actually referred or referenced by a member for particular positions. According to embodiments, a credibility score module may be configured to store one or more credibility scores associated with a member's performance within the system, for example, over specific period of time or over the duration of a user's membership. Embodiments provide for a rewards module that may be configured to store accounting details, such as one or more rewards awarded to a member for past services, account details, and the like. Each of the modules may be configured according to embodiments to execute computer program code configured to carry out specific acts or functions associated with storing, updating, or modifying, relevant information associated with the functionality of the module. Moreover, systems consistent with embodiments may contain more or less modules than illustrated, such as two modules being consolidated and/or additional modules being added for executing functionality consistent with the systems and methods described herein. Moreover, the modules may be linked or combined in a variety of ways depending upon the particular use contemplated.

Each of the modules may be configured according to embodiments to execute computer program code configured to carry out specific acts or functions associated with storing, updating, or modifying, relevant information associated with the functionality of the module. Moreover, systems consistent with embodiments may contain more or less modules than illustrated, such as two modules being consolidated and/or additional modules being added for executing functionality consistent with the systems and methods described herein. Moreover, the modules may be linked or combined in a variety of ways depending upon the particular use contemplated.

Embodiments may provide a member home page for display on a member's device, such as a personal computer, cell phone, or other computing device. The member home page may contain a variety of functional units for executing commands requesting that a system as described herein perform functions consistent with those described herein. For example, a member homepage may include, but is not limited to, providing an email client, a messaging client, an accounting client, and an invite/recruiting client. The invite/recruiting client may provide functionality supporting member recruiting activities, such as providing an option to invite a new member to join the system, invite an existing member to become part of the particular member's personal network, and conducting recruiting services such as selecting another member and referring them as a candidate for a job opening. The accounting client may provide accounting services to the member, such as linking a member account to that of a financial institution such that the rewards issued to a member can be direct deposited into the member's account at a given financial institution.

In addition, the member home page may include a variety of tabs that, in response to selection, provide a convenient display of member activities. A contacts tab may be provided that displays a list of contacts of the member upon selection. The contacts may include both member network contacts within the system as well as member contacts as derived from one or more external networks, such as online social graphs, including social networking sites to which the member belongs. A jobs listing tab, may include, for example, a listing of jobs deposited within the system by clients looking to fill open positions. A rewards tab may include a listing of current, past or pending rewards a member has or can obtain via activities within the system. A credibility score tab may include the member's credibility score regarding referral activities within the system. A referrals tab may include a listing of referrals the member has made. A references tab may include a list of references the member has made.

Furthermore, the member's home page may include links to other web sites, such as other social networking web sites the member belongs to or web sites dedicated to certain professional organizations. The member's home page may also include a search function such that the member may search within the system for other pages, such as pages of other members, or for posted jobs. The member's homepage according to certain embodiments may display one or more member rankings or credibility scores, viewable by other members.

Embodiments may utilize one or more categories of the member information to implement a metric-based scoring (“ranking”) of the members. Key metrics used may include, but are not limited to, customer satisfaction with the member; number of members registered as a result of invitations sent by the member; utilization of the member's services; a member metric combining one or more member information categories, such as a member “batting average” (customer satisfaction combined with utilization), and/or a member “runs batted in” (customer satisfaction combined with number of recruits as compared with customer satisfaction combined with utilization); and the quality of the members referrals. Certain embodiments are configured to utilize a metrics based scoring system in order to ensure an aggressive quality assurance program regarding the members. In this way, those considering using one or more of the member's services can gain assurance that a member and referrals made by the member are of the utmost quality based on past performance.

As discussed herein, certain embodiments are configured to make the referral decision matter more than is usual to the member. In addition to receiving a reward, the member should be cognizant of the potential negative implications of making an inappropriate referral. Such negative implications may include, but are not limited to, a reduction in the member's rating, ranking, and/or credibility score within the system, which is visible to others.

Typical factors affecting the hiring decision are education, experience, and one or more references. Certain embodiments are configured to enable those making hiring decisions to have more confidence in the reference(s) submitted. Those making hiring decisions should take into account why they need a reference, how often they receive a negative one, and how they can verify the reference, and whether a member making a reference is accountable for the quality of the reference in some way. Accordingly, certain embodiments are configured to make references matter to those involved as acting as a reference or making a referral. By way of example, certain embodiments are configured to measure the quality of a particular reference's past performance in that capacity and make that past performance accessible to others considering reliance on the reference. Moreover, certain embodiments may correlate reward level to member ranking in this regard, thus tying compensation level to credibility within the system. Thus, certain embodiments are configured to score members over time such that an accountability is attached to the each reference, and that accountability (for example, ranking) follows the member over time.

Certain embodiments are configured to rank a reference utilizing detailed reference rankings as one or more member rankings, and associate them with members choosing to act as references. The detailed reference rankings take into account how accurate the reference's description was, how satisfied the recipient of the reference was, how responsive the reference was to submitted communications and questions, and the like, by implementing a user interface wherein a hiring manager can review the performance of the reference at a later time. Thus, certain embodiments are configured to provide quality assurance in the form of a credibility index or score for references, such as reflected by a member's customer satisfaction score. Such visibility and accountability within the system will make decisions by hiring managers easier inasmuch as they will have some qualitative way of determining how reliable a particular reference is likely to be. Moreover, long term incentives may attach to members acting as references. For example, certain embodiments are configured to remove recruiter privileges from a member if his or her credibility index drops below a certain predetermined threshold value. In another example, embodiments may provide enhanced job listings, such as the ability to view job listings before other members, to members with a score above a certain threshold.

A talent management platform according to embodiments is configured to obtain information from members. According to embodiments, such information includes, but is not limited to, networks, connections, or online communities associated with the member, resume information, talent management platform profile information, and other accessible personal information. The terms networks, connections, and online communities are collectively referred to as “member networks” within this specification, unless specified otherwise or discussed individually.

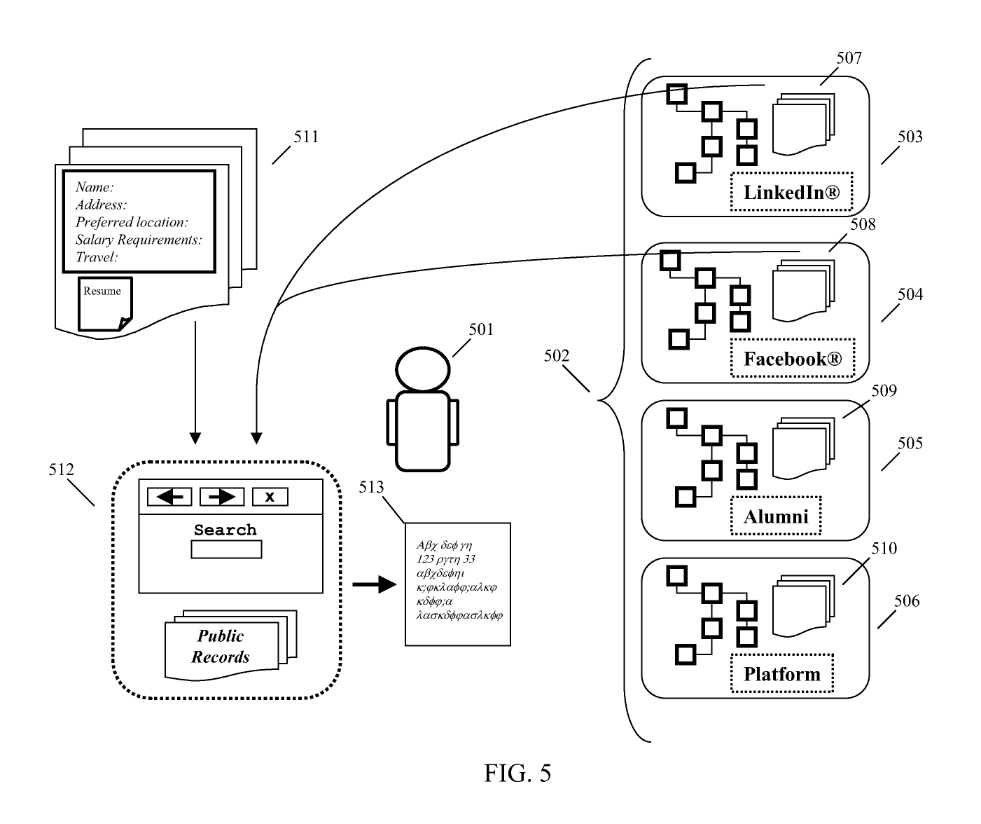

In FIG. 5, therein is provided an example of information available to the talent management platform according to an embodiment. A platform member 501 belongs to certain member networks 502, non-limiting examples provided in FIG. 5 include the social networks LinkedIn® 503 and Facebook® 504, an alumni network 505, and the platform network 506. The member networks 503 each have their own set of data 507-509, including network profile data, connections, and profile data of the connections.

Also shown in FIG. 5, information may be available through profile information supplied to the platform 510. Such information may include name and address information, a resume, and other personal information, such as preferred geographical region, desired position, willingness to travel, and salary requirement information. FIG. 5 also provides that information may be obtained through information gathering and analysis 511, which includes generating inferences from the available information, searching for publicly available information, such as public government records and information available online, and generating a profile for a specific member or candidate based on the located information.

Embodiments provide that a member may interact with the talent management platform in multiple ways, for example, as a job seeker or to refer candidates. Embodiments provide for a recommendation engine configured to locate and recommend high quality candidates for positions or to recommend jobs to members. According to embodiments, the recommendation engine is configured to access social graphs associated with platform members and their connections, and to obtain information available from the social graphs, such as profile and connection information. Embodiments may analyze the available information associated with platform members, connected social graphs, and profile information of social graph members connected to platform members and generate certain assumptions, inferences, and related information. Embodiments provide that the recommendation engine may analyze member networks and recommend potential candidates located therein for open positions. In addition, embodiments provide that the recommendation engine is configured to recommend jobs to talent management platform members. According to embodiments, the recommendation engine may obtain member information, analyze available job listings, and provide recommendations of available jobs that fit the member information.

Embodiments are configured to utilize member social graphs including, but not limited to, the talent management platform network, social networks, alumni networks, technology councils, and professional networks. For example, a talent management platform according to embodiments may require that members provide or join the platform using social network credentials. Embodiments are configured to obtain information from the member networks for use in determining candidate recommendations, including, but not limited to, member profile information, member connections, and profile information from the connections. According to existing technology, the API's of certain member networks, such as the social networks LinkedIn® and Facebook®, have been made publicly available. As such, embodiments may access the API's of social networks used by members and obtain their connections within said social networks. However, embodiments are not limited to accessing member networks through available API's, as any applicable method for obtaining information from member networks may be applied.

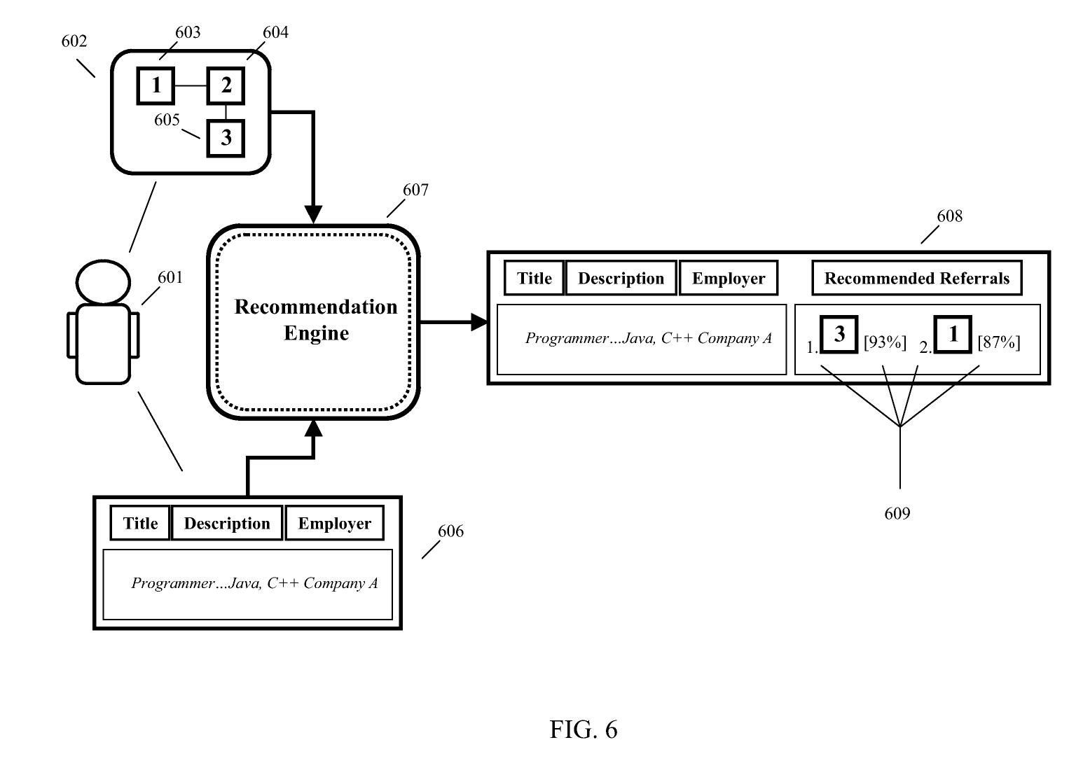

Referring to FIG. 6, therein is depicted an example recommendation engine accessing a member network and providing position referrals according to an embodiment. A talent management platform member 601 is a member of a social network 602 with social network connections 603. The member 601 selects a job listing 604 posted on the talent management platform, resulting in the recommendation engine 605 accessing the social network connections 603. The recommendation engine 605 analyzes the social network connections 603 based on certain candidate factors obtained from the job listing 604 and provides a set of recommendations 606 selected from the social network connections 603. In the example provided in FIG. 6, the recommendations are ranked and scored 609 according to how well they fit the job listing 606

According to embodiments, the recommendation engine retrieves member, candidate, and job information from available sources and analyzes this information to generate a job or candidate recommendation. As described above, job referral and search platforms according to existing methods are mainly capable of comparing jobs and candidates using limited keyword search related processes. A keyword search example involving the following job listing may illustrate such methods:
Large Corporation A is seeking a database administrator with at least five years of experience with SQL databases. Must have at least a bachelor's degree in computer science, information sciences, or a related degree. The position is for our City B office, but requires travel to our other regional facilities as required.
   A keyword-based search of networks, connections, or online communities for the above listing may generate many potential candidates who have five years or more of database experience, experience with SQL, or have one of the required degrees. However, a large majority of these candidates are most likely not a good fit for the position. For example, certain candidates may have to relocate for this position, but may not want to relocate to this particular area. In addition, potential candidates may have other characteristics that are not readily quantifiable that may cause them to not be a good fit for the posted position. For example, potential candidates may not want to work in City B, may prefer not to work for a large corporation, may not want to travel for work, or may simply not be interested in a new position. However, referral and job searching platforms according to existing technology do not consider these subjective, or qualitative, characteristics and would likely recommend such candidates. Accordingly, existing methods generate low quality referrals and job recommendations with many false positives. Embodiments provide for a recommendation engine that provides high quality job referrals using, inter alia, qualitative candidate factors. According to embodiments, a recommendation engine analyzes position information for a posted job and information from known candidates to determine a set of potential candidates, the recommendation engine then analyzes the subjective or qualitative information associated with the set of potential candidates to make one or more referrals for the posted job. Embodiments provide that the subjective or qualitative information may be obtained through multiple methods, including, but not limited to, being supplied by the subject (e.g., supplied through a questionnaire or profile form), through inferences generated based on known information, and by using known information to search and locate subjective information from other information sources (e.g., publicly available information sources, Internet searches).

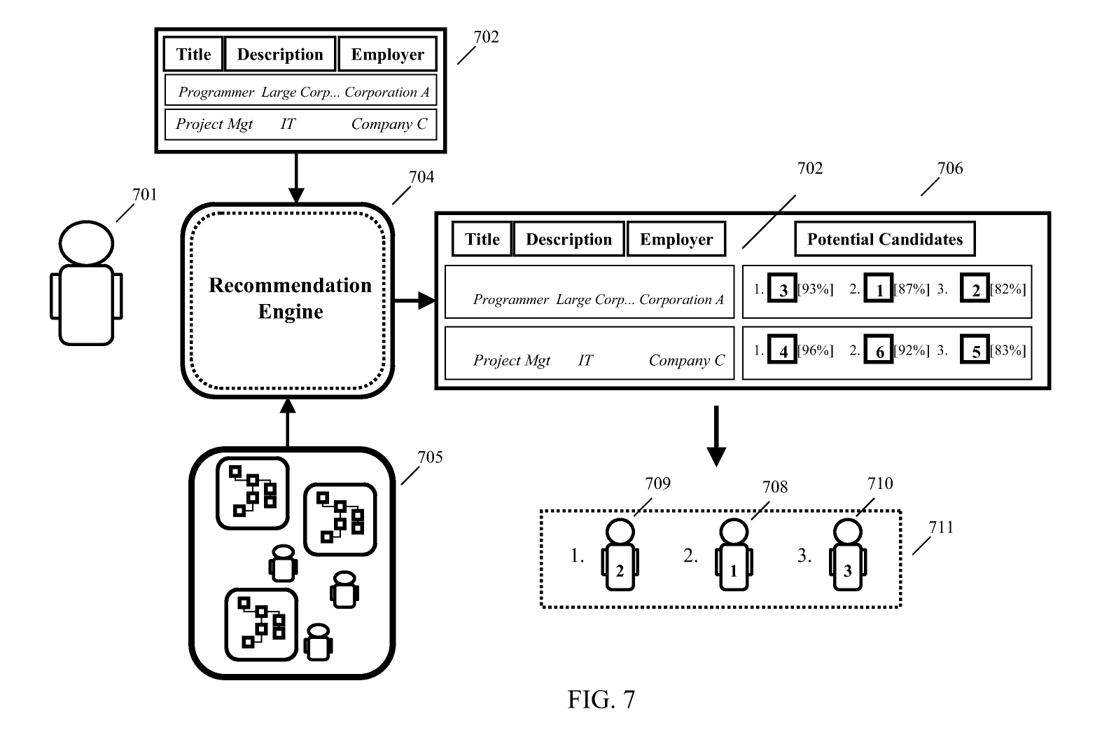

Referring to FIG. 7, therein is depicted an example of a recommendation engine searching for candidates for a job listing using the talent management platform according to an embodiment. A talent management platform member 701 accesses the job listings 702 available through the platform intending to make a referral. For each job listing 702, the recommendation engine 704 searches through the member networks 705 associated with the member 701 and provides a ranked list of potential candidates 706. In the example shown in FIG. 7, a first job listing 707 has a description, which is the same as the “Large Corporation A” example given above. The recommendation engine 704 obtains the description and parses the information for analyzing potential candidates. Information from member networks 705 is also obtained by the recommendation engine 704, which analyzes this information with the data obtained from the job description.

As shown in FIG. 7, the recommendation engine 704 locates a first set of candidates 706 that meet the basic requirements outlined in the first job listing 707 description, such as experience with SQL databases, an applicable academic background, and the requisite experience. However, most of these candidates will likely not be a quality referral for the member 701. As such, the recommendation engine 704 also evaluates relevant qualitative candidate factors that are indicative of a quality referral. For example, the recommendation engine 704 may be configured according to embodiments to increase the ranking score of candidates whose current position is just below that described in the job listing, and maintain or decrease the ranking score of those who would be making a lateral or backward move if they took the position. This may be because, inter alia, the recommendation engine 704 has learned, through heuristics, machine learning or otherwise, that candidates who would be moving up by taking the new position are more likely to be interested in the job listing and, therefore, make higher quality referrals. In FIG. 7, Candidate 1 708 is currently employed as a database analyst, while Candidate 2 709 is currently employed as a database administrator. As such, the recommendation engine 704 may increase the ranking score of Candidate 1 708 because his current position, database analyst, is just below that of the database administrator position described in the first job listing 706 description.

In FIG. 7, the information obtained regarding Candidate 3 710 indicates a pattern of changing jobs every four to five years, while Candidate 2 709 has been in the same position for twelve years. Embodiments provide that the recommendation engine 704 may increase the ranking score of candidates that are likely to be ready for a new position based on past work experience, and maintain or decrease a ranking score of candidates who demonstrate a pattern of staying in a position for a relatively long period of time. As such, the recommendation engine 704 may increase the ranking score of Candidate 3 710 and decrease the ranking score of Candidate 2 709. In the non-limiting example depicted in FIG. 7, the recommendation engine 704 has analyzed the potential candidates 706 and has generated a ranked list of referrals 711 for the first job listing. As demonstrated in FIG. 7, according to embodiments, potential candidate rankings do not necessarily reflect the actual referral rankings, as Candidate 2 709 was ranked as the third potential candidate 706 but was ranked as the first referral 711.

A recommendation engine according to embodiments may arrive at different conclusions with the same data depending on experience with referred applicants, such as through user feedback or input regarding the success of referrals. As a non-limiting example involving Candidate 3 511 and Candidate 4 512, the recommendation engine 508 may determine that Candidate 3 511 may not be a good fit for a high level position, such as an administrative or management position because of his pattern of only staying in a job for three years, while the career path of Candidate 4 512 may indicate a pattern more suitable for such high level positions. As such, embodiments provide that the recommendation engine may learn and improve its referral process based on feedback data concerning past referrals.

Embodiments provide that any qualitative or subjective factor that may have an affect on the ranking of referral candidates may be considered by the recommendation engine. According to embodiments, such qualitative factors include, but are not limited to, how close the candidate lives to the position location; whether the candidate has shown a willingness to change jobs; whether the candidate prefers large, medium, or small firms; whether the candidate prefers established organizations or start-ups; credit score; criminal history or lack thereof; candidate organizations, such as professional or alumni organizations; social graph information, such as social network information, including, but not limited to, profiles, pictures, postings, and connection information; whether the candidate has demonstrated a pattern of changing jobs for increased levels of responsibility or a pattern of lateral moves; or whether the candidate has indicated a desire to work with a particular technology or industrial sector.

As previously described herein, embodiments provide for enhanced analysis of potential candidates and available job listings by obtaining and examining candidate social network information. Using the social network LinkedIn® as an illustrative and non-restrictive example, embodiments may analyze information obtained from the available fields, such as “specialties,” “interests,” “patents,” and “twitter-accounts.” In this example, a recommendation engine according to embodiments may compare what a potential candidate considers to be his specialties with what is listed on their resume. In addition, the recommendation engine may be able to see if a potential candidate's interests shed some light on his fitness for the job. For example, if the candidate's interests include travel, which is also a job requirement, the recommendation engine may increase his ranking score. Furthermore, whether a potential candidate has been involved in a patent may have a bearing on the candidate's fitness. For example, a recommendation engine according to embodiments may obtain any patents listed by the LinkedIn® member and examine them in view of the job requirements. In another example, the recommendation engine may use the fact that the potential candidate has listed several patents to indicate his level of experience or position within a particular organization. Moreover, a recommendation engine according to embodiments may access Twitter® accounts listed in the twitter-accounts field to obtain even further information regarding a potential candidate. Twitter® is a registered trademark of Twitter, Inc.

Another illustrative and non-restrictive example involves the Facebook® social network, where embodiments may access the member information for use in making referrals and recommending jobs. Illustrative information may involve Facebook® social graph connections, including, but not limited to, “friends,” “likes,” “events,” “groups,” “profile feed,” and “photo albums.” In this non-limiting Facebook® example, a recommendation engine according to embodiments may use information from the friends connection to access a member's connections as possible referral candidates. In addition, the recommendation may access and analyze a Facebook® member's photo albums for information pertinent to a particular job listing. For example, a photo album may indicate whether a potential candidate is highly social or not, which may be applicable to certain job categories, such as managerial or sales positions.

As previously described herein, embodiments provide for enhanced analysis of potential candidates and available job listings by obtaining and examining publicly available information about potential candidates. A non-limiting example provides that a recommendation engine according to embodiments may access publicly available information, including, but not limited to, public records, government records, and Internet search results, and use this information to analyze a candidate's fitness for a particular position. Illustrative examples include criminal records, credit reports, blogs, web sites, and other Internet activity.

In addition to referring candidates, embodiments provide that the recommendation engine may be used by talent management platform members to locate jobs. As described previously, certain platforms for matching job seekers with positions, for example, MONSTER.COM®, operate mainly using rudimentary keyword search methods. As such, candidates often receive a list of jobs where the candidate may only be interested in a small fraction. As such, embodiments provide a recommendation engine configured for enhanced job searching such that candidates receive a ranked list of jobs specifically relevant to their unique search characteristics. For example, similar to candidate referral embodiments discussed above, a recommendation according to embodiments may use information such as member profile, resume, and social networking information to recommend jobs to a user. As a non-limiting example, the recommendation engine may know from a talent management platform member profile that the member only wants to work with wireless technology, does not want to work in database administration and related fields, wants to work for a large company, and wants to work within twenty miles of his residence. Such information is not readily obtained from a candidate resume, however a talent management platform according to embodiments may be configured to request such personal and professional information from a candidate for use in the platform recommendation engine. In this example, the recommendation engine may increase the ranking score of job listings involving wireless technology, and may eliminate or decrease the ranking score of job listings outside of the member specified geographic area.

In addition, a recommendation engine according to embodiments may use member social network information to rank recommended jobs. In a non-limiting example, the recommendation engine may access the “specialties” field of a member's LinkedIn® profile and increase the ranking score of job listings associated with those specialties. For example, a programmer may list Java® programming as a skill on his resume and may include “embedded systems programming” as his specialty in his LinkedIn® profile. Java® is a registered trademark of Oracle and/or its affiliates. According to embodiments, the recommendation engine may increase the score of job listings associated with Java® embedded systems programming over job listings that just list Java® experience as a requirement.

As described above, embodiments may access jobs from multiple sources, such as employer job listings, private entity job listings, and staffing agency job listings. In addition, embodiments provide that the talent management platform may locate and list jobs from other sources, including the Internet, such as from for-profit job boards (e.g., Monster®), university job boards, government job postings, and company web sites.

A recommendation engine according to embodiments processes multiple data inputs when generating candidate or job recommendations. For example, embodiments provide for job, member, and member network information. In addition, embodiments are configured to accept and analyze other forms of information, such as member or candidate preference information. According to embodiments, preference information may involve member preferences, such as wanting to work at a smaller, more entrepreneurial firm in favor of a large firm, wanting to work with a particular technology, or preferring jobs that represent an increase in position or pay in favor of positions involving a lateral move. Embodiments provide that such preference information may be collectively referred to as a “member profile.” In one illustration, a member seeking to refer candidates for a job may specify that he does not want a certain connection in his network to be recommended for all jobs or just specific jobs. For example, a member may know that a member network connection is not interested in a new job or that the candidate may only be interested in database administrator positions. In another example, a member looking for a job may specify that he is only interested in programming jobs in a particular language, although he may be qualified for a broad range of programming jobs.

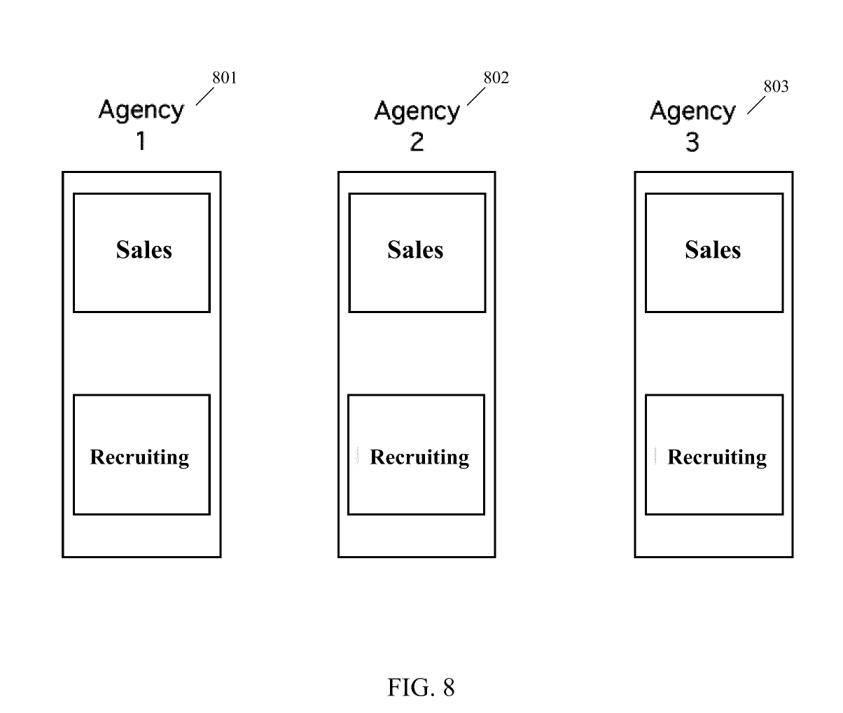

Embodiments provide for a job referral exchange comprising a “marketplace” of jobs, referrals, and job candidates. A recruiting agency consists of two main functions, sales and recruiting. The sales function involves finding qualified candidates for positions at the request of clients. The recruiting function concerns finding positions for candidates using the agency to obtain employment or find another job. As shown in FIG. 8, according to current technology, multiple agencies 801-803 each have their own individual sales and recruiting functions without any real overlapping or sharing of resources, jobs, or candidates. Embodiments provide a job referral exchange that supplies an opportunity for multiple agencies, HR departments, and employers to access open positions and referrals in a marketplace environment.

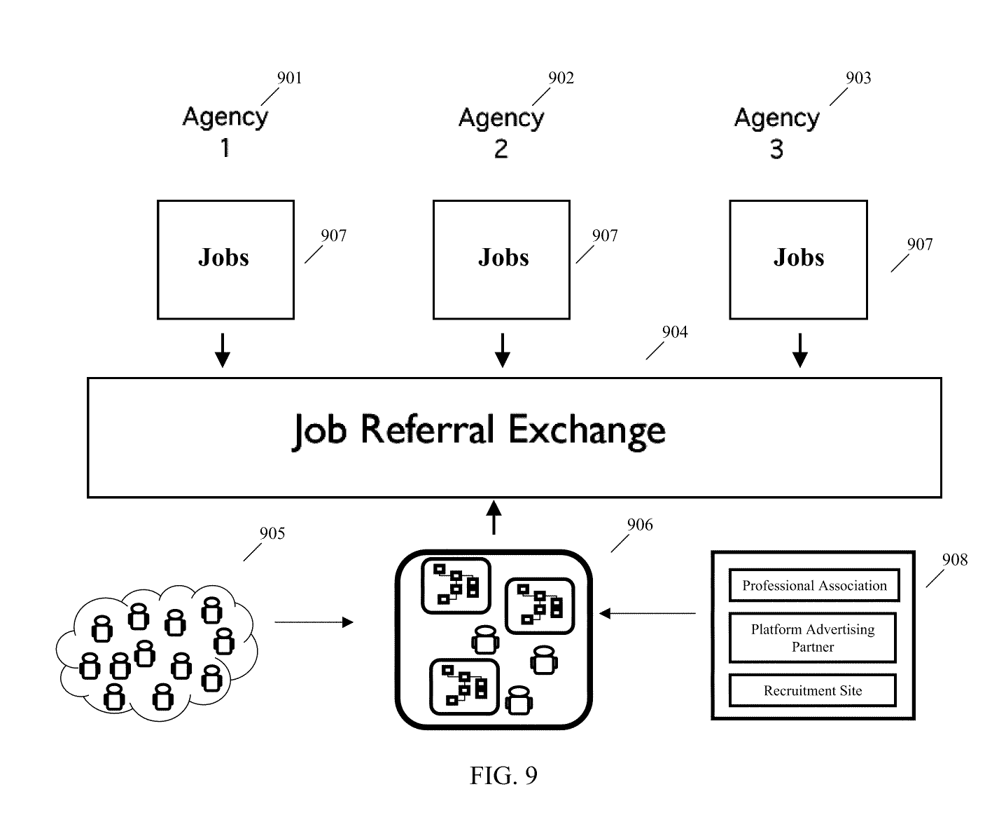

Referring to FIG. 9, therein is depicted an example job referral exchange according to an embodiment. In FIG. 9, the sales (jobs) 907 from multiple agencies 901-903 may be input into the job referral exchange 904 to provide a pool of available jobs. In addition, the candidates 905 associated with the agencies 901-903 may be registered with the talent management platform 906 and combined with members already associated with the talent management platform 906 and their network connections as a pool of candidates available to fill the jobs 907 provided within the job referral exchange. According to embodiments, the jobs 907 available through the job referral exchange 904 may be input into a recommendation engine (not shown) according to embodiments and the resultant referrals input into the job referral exchange 904 and made available to the agencies 901-903. In addition, other recruitment vehicles 908, such as professional recruitment web sites, professional associations, and advertising partners may provide input of potential candidates to the talent management platform 906.

Embodiments provide for a talent management platform user interface wherein a member may access multiple aspects of the platform from a unified interface. As a non-limiting example, the member may access the interface and view a list of connections, which may comprise platform network connections or external network connections (e.g., social network connections), and associated information. For each connection, a list of jobs wherein the connection may be a quality referral may be listed along with information related to each listed job. As such, a user may view all of his connections and all available jobs where the connection may be a quality referral from a common interface. According to embodiments, the member may select to view all of the available jobs and the interface would display potential referrals derived from the member's connections. In addition, embodiments provide that the member may be able to use the interface to view all available jobs, for example, ranked by how well they fit the member's profile and qualifications.

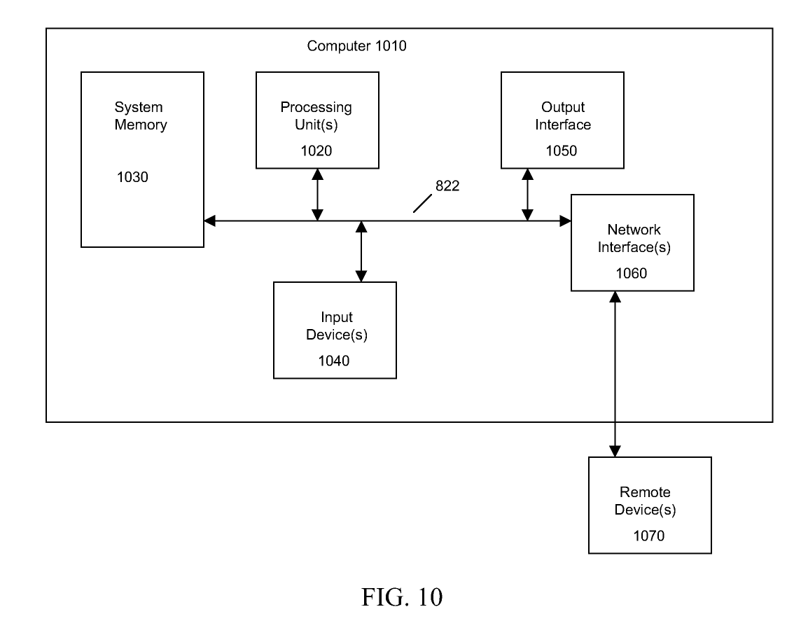

Referring to FIG. 10, it will be readily understood that certain embodiments can be implemented using any of a wide variety of devices or combinations of devices. An example device that may be used in implementing one or more embodiments includes a computing device in the form of a computer 1010.

Components of computer 1010 may include, but are not limited to, a processing unit 1020, a system memory 1030, and a system bus 1022 that couples various system components including the system memory 1030 to the processing unit 1020. The computer 1010 may include or have access to a variety of computer readable media. The system memory 1030 may include computer readable storage media in the form of volatile and/or nonvolatile memory such as read only memory (ROM) and/or random access memory (RAM). By way of example, and not limitation, system memory 1030 may also include an operating system, application programs, other program modules, and program data.

A user can interface with (for example, enter commands and information) the computer 1010 through input devices 1040. A monitor or other type of device can also be connected to the system bus 1022 via an interface, such as an output interface 1050. In addition to a monitor, computers may also include other peripheral output devices. The computer 1010 may operate in a networked or distributed environment using logical connections to one or more other remote computers or databases. The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
one or more processors;
a system memory operatively coupled to the one or more processors; and
one or more professional talent management modules communicatively coupled to the system memory, wherein the one or more professional talent management modules are adapted to:
register one or more system members arranged in a system network, the one or more system members belonging to one or more external networks and having member profile information;
obtain external network profile information from the one or more external networks;
list one or more positions comprising position information; and
configure a recommendation engine to generate position decisions for the one or more positions, the recommendation engine adapted to:
analyze the external network profile information to generate candidate subjective information; and
refer one or more candidates for the one or more positions by applying the subjective information and the external network profile information to the position information.

2. The system according to claim 1, wherein the one or more external networks are social networks.

3. The system according to claim 2, wherein the external network profile information comprises information from available social network profile fields.

4. The system according to claim 1, wherein the one or more referrals are ranked according to a fitness of the one or more referrals to the one or more positions.

5. The system according to claim 1, wherein subjective information comprises whether a candidate is willing to relocate, level of a current position of a candidate in relation to the one or more positions, and how long a candidate has been in a current position.

6. The system according to claim 1, wherein the recommendation engine is further adapted to:
analyzing the member profile information to obtain member subjective information;
recommend one or more positions to the one or more members by applying the member profile information and the member subjective information to the position information.

7. The system according to claim 1, wherein the member profile information comprises one or more member preferences.

8. The system according to claim 7, wherein the one or more member preferences comprise a geographic location, salary range, and commute distance.

9. The system according to claim 1, wherein the member profile information comprises one or more candidate preferences.

10. The system according to claim 2, wherein the one or more professional talent management modules are further adapted to:
obtain social network credentials from the one or more members; and
access the one or more social networks associated with a member using the credentials supplied by the member;
wherein obtaining external network profile information comprises accessing social network profiles of social network connections connected to the member within the one or more social networks;
wherein analyzing the external network profile information to generate candidate subjective information comprises analyzing the social network profiles of each social network connection to generate inferences based on information contained within the social network profiles, the inferences relating to employment patterns and professional fitness of the social network connection;
wherein subjective information comprises whether a candidate is willing to relocate, level of a current position of a candidate in relation to the one or more positions, and how long a candidate has been in a current position.

11. A method comprising:
registering one or more system members arranged in a system network, the one or more system members belonging to one or more external networks and having member profile information;
obtaining external network profile information from the one or more external networks;
listing one or more positions comprising position information; and
configuring a recommendation engine to generate position decisions for the one or more positions, the recommendation engine adapted to:
analyze the external network profile information to generate candidate subjective information; and
refer one or more candidates for the one or more positions by applying the subjective information and the external network profile information to the position information.

12. The method according to claim 11, wherein the one or more external networks are social networks.

13. The method according to claim 12, wherein the external network profile information comprises information from available social network profile fields.

14. The method according to claim 11, wherein the one or more referrals are ranked according to a fitness of the one or more referrals to the one or more positions.

15. The method according to claim 11, wherein subjective information comprises whether a candidate is willing to relocate, level of a current position of a candidate in relation to the one or more positions, how long a candidate has been in a current position.

16. The method according to claim 11, wherein the recommendation engine is further adapted to:
analyzing the member profile information to obtain member subjective information;
recommend one or more positions to the one or more members by applying the member profile information and the member subjective information to the position information.

17. The method according to claim 11, wherein the member profile information comprises one or more member preferences.

18. The method according to claim 17, wherein the one or more member preferences comprise a geographic location, salary range, and commute distance.

19. The method according to claim 11, wherein the member profile information comprises one or more candidate preferences comprising one or more candidates to be omitted from the one or more referrals.

20. A computer program product comprising:
a computer readable storage medium having computer readable program code embodied therewith, the computer readable program code comprising:
computer readable program code configured to register one or more system members arranged in one or more system networks, each of the one or more members belonging to one or more external networks;
computer readable program code configured to register one or more system members arranged in a system network, the one or more system members belonging to one or more external networks and having member profile information;
computer readable program code configured to obtain external network profile information from the one or more external networks;
computer readable program code configured to list one or more positions comprising position information; and
computer readable program code configured to configure a recommendation engine to generate position decisions for the one or more positions, the recommendation engine adapted to:
analyze the external network profile information to generate candidate subjective information; and
refer one or more candidates for the one or more positions by applying the subjective information and the external network profile information to the position information.
